(19) United States
(12) Patent Application Publication
(10) Pub. No.: US 2025/0206023 A1
(43) Pub. Date: Jun. 26, 2025

(54) Method Of Manufacturing Nozzle Plate, Liquid Ejecting Head, And Liquid Ejecting Apparatus

(71) Applicant: SEIKO EPSON CORPORATION, Tokyo (JP)

(72) Inventors: Yoichi NAGANUMA, Matsumoto (JP); Naohiro NAKAGAWA, Matsumoto (JP); Shohei MIZUTA, Matsumoto (JP)

(21) Appl. No.: 18/987,125

(22) Filed: Dec. 19, 2024

(30) Foreign Application Priority Data
Dec. 20, 2023 (JP) 2023-214733

(51) Int. Cl. B41J 2/16; B41J 2/14

(52) U.S. Cl. CPC B41J 2/162; B41J 2/1433; B41J 2/1629; B41J 2/164; B41J 2202/03

(57) ABSTRACT

Provided is a method including: preparing a substrate, in which a first nozzle layer formed from silicon, an intermediate layer formed from silicon oxide, and a second nozzle layer formed from silicon are laminated in enumerated order and a space portion is provided at a portion of the intermediate layer; providing a first nozzle opening that communicates with the space portion by conducting a Bosch process on a first region where at least a portion of the first nozzle layer overlaps the space portion, the providing the first nozzle opening being carried out after the preparing; and providing a second nozzle opening that communicates with the space portion and has a larger diameter than a diameter of the first nozzle opening by conducting a Bosch process on a second region where at least a portion of the second nozzle layer overlaps the space portion.

The present application is based on, and claims priority from JP Application Serial Number 2023-214733, filed Dec. 20, 2023, the disclosure of which is hereby incorporated by reference herein in its entirety.

### BACKGROUND

### 1. Technical Field

The present disclosure relates to a method of manufacturing a nozzle plate provided with nozzles for ejecting a liquid, a liquid ejecting head that ejects a liquid, and a liquid ejecting apparatus provided with the liquid ejecting head.

### 2. Related Art

A liquid ejecting apparatus as typified by an ink jet printing apparatus such as an ink jet printer includes a liquid ejecting head that can eject a liquid such as an ink stored in a cartridge, a tank, and the like in the form of liquid droplets.

The liquid ejecting head includes a nozzle plate provided with nozzles for ejecting the liquid droplets. A certain nozzle may include a first nozzle opening provided on an ejecting surface side and a second nozzle opening communicating with the first nozzle opening and having a larger diameter than that of the first nozzle opening. In order to set ejection characteristics of the liquid droplets to be ejected from the aforementioned nozzle such as ejection speeds and weights of the liquid droplets to targeted values, it is necessary to form the first nozzle opening without an error in length. When the first nozzle opening is formed by ordinary etching, the length of the first nozzle opening is adjusted by controlling an etching period. However, this operation may cause an error due to the nature of time control. Given the circumstances, there has been proposed a nozzle plate using an SOI substrate constructed by interposing an insulating film such as silicon oxide between two silicon substrates (see JP-A-2018-51833, for example).

However, formation of the first nozzle opening by ordinary etching while using the SOI substrate for the nozzle plate may cause the following problem. Specifically, ions may be bent by a charged insulating film when causing the insulating film to function as an etching stop layer. Accordingly, a phenomenon so-called notching is developed by widely etching a portion of a side wall of the first nozzle opening on the insulating film side, which may result in a failure to obtain a desired shape as the first nozzle opening, thus leading to a failure to obtain desired ejecting characteristics in some cases.

### SUMMARY

An aspect of the present disclosure to solve the above-mentioned problem provides a method of manufacturing a nozzle plate provided with a nozzle and configured to be attached to a liquid ejecting head, including: preparing a substrate, in which a first nozzle layer formed from silicon, an intermediate layer formed from silicon oxide, and a second nozzle layer formed from silicon are laminated in enumerated order and a space portion is provided at a portion of the intermediate layer; providing a first nozzle opening that communicates with the space portion by conducting a Bosch process on a first region where at least a portion of the first nozzle layer overlaps the space portion, the providing the first nozzle opening being carried out after the preparing; and providing a second nozzle opening that communicates with the space portion and has a larger diameter than a diameter of the first nozzle opening by conducting a Bosch process on a second region where at least a portion of the second nozzle layer overlaps the space portion.

Another aspect of the present disclosure provides a liquid ejecting head including: a nozzle plate provided with a nozzle; and a pressure chamber substrate provided with a pressure chamber configured to apply a pressure to a liquid in order to eject the liquid from the nozzle, in which a first nozzle layer formed from silicon, an intermediate layer formed from silicon oxide, and a second nozzle layer formed from silicon are laminated in an enumerated order in the nozzle plate, the first nozzle layer is provided with a first nozzle opening, the intermediate layer is provided with a space portion that communicates with the first nozzle opening, the second nozzle layer is provided with a second nozzle opening that communicates with the space portion and has a larger diameter than a diameter of the first nozzle opening, a scallop is formed at each of the first nozzle opening and the second nozzle opening, and a scallop is not formed at the space portion.

Still another aspect of the present disclosure provides a liquid ejecting apparatus including the liquid ejecting head according to the above-mentioned aspect.

### BRIEF DESCRIPTION OF THE DRAWINGS

FIG. 1 is a diagram illustrating a schematic configuration of a liquid ejecting apparatus according to Embodiment 1.

FIG. 2 is an exploded perspective view of a liquid ejecting head according to the Embodiment 1.

FIG. 3 is a plan view of a main portion of the liquid ejecting head according to the Embodiment 1.

FIG. 4 is a cross-sectional view of the main portion of the liquid ejecting head according to the Embodiment 1.

FIG. 5 is an enlarged cross-sectional view of a main portion of a nozzle plate according to the Embodiment 1.

FIG. 6 is an enlarged cross-sectional view of a main portion illustrating a modified example of the nozzle plate according to the Embodiment 1.

FIG. 7 is an enlarged cross-sectional view of a main portion illustrating another modified example of the nozzle plate according to the Embodiment 1.

FIG. 8 is an enlarged cross-sectional view of a main portion illustrating another modified example of the nozzle plate according to the Embodiment 1.

FIG. 9 is a cross-sectional view illustrating a method of manufacturing the nozzle plate according to the Embodiment 1.

FIG. 10 is another cross-sectional view illustrating the method of manufacturing the nozzle plate according to the Embodiment 1.

FIG. 11 is another cross-sectional view illustrating the method of manufacturing the nozzle plate according to the Embodiment 1.

FIG. 12 is another cross-sectional view illustrating the method of manufacturing the nozzle plate according to the Embodiment 1.

FIG. 13 is another cross-sectional view illustrating the method of manufacturing the nozzle plate according to the Embodiment 1.

FIG. 14 is another cross-sectional view illustrating the method of manufacturing the nozzle plate according to the Embodiment 1.

FIG. 15 is another cross-sectional view illustrating the method of manufacturing the nozzle plate according to the Embodiment 1.

FIG. 16 is an enlarged cross-sectional view of a main portion of a nozzle plate according to Embodiment 2.

FIG. 17 is a cross-sectional view illustrating a method of manufacturing the nozzle plate according to the Embodiment 2.

FIG. 18 is another cross-sectional view illustrating the method of manufacturing the nozzle plate according to the Embodiment 2.

FIG. 19 is another cross-sectional view illustrating the method of manufacturing the nozzle plate according to the Embodiment 2.

FIG. 20 is another cross-sectional view illustrating the method of manufacturing the nozzle plate according to the Embodiment 2.

### DESCRIPTION OF EMBODIMENTS

The present disclosure will be described below in detail based on embodiments. It is to be noted, however, that the following description is intended to represent certain aspects of the present disclosure, which can be arbitrarily modified within the scope of the present disclosure. Constituents designated by the same reference signs in the respective drawings represent the same constituents, and explanations thereof are omitted as appropriate. In the meantime, x, y, and z in the respective drawings represent three spatial axes that are orthogonal to one another. In the present specification, directions along these axes will be defined as x direction, y direction, and z direction, respectively. Each direction in the respective drawings to which an arrow is oriented will be explained as a positive (+) direction and a direction opposite to the arrow will be explained as a negative (−) direction. Meanwhile, the z direction represents a vertical direction. Here, +z direction represents a vertically downward direction while −z direction represents a vertically upward direction. Moreover, the directions along the three spatial axes without specifying the positive direction or the negative direction will be explained as x axis direction, y axis direction, and z axis direction, respectively.

### Embodiment 1

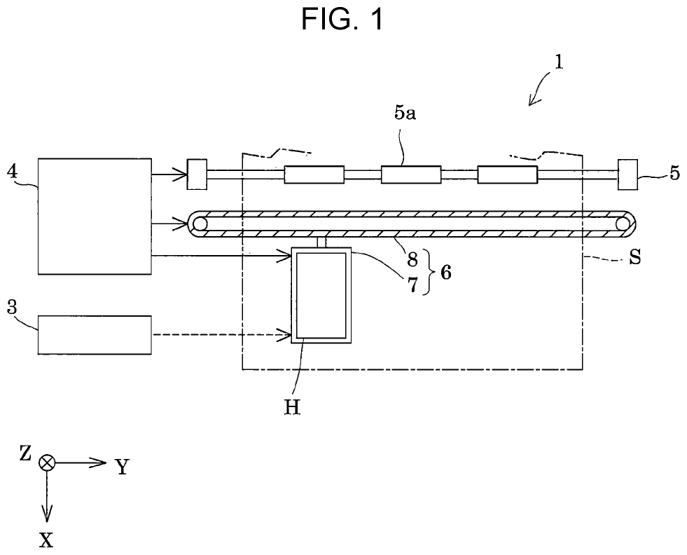

FIG. 1 is a diagram illustrating a schematic configuration of a liquid ejecting apparatus 1 according to Embodiment 1 of the present disclosure.

As illustrated in FIG. 1, the liquid ejecting apparatus 1 is a so-called serial printer, which includes a liquid ejecting head H and performs printing by ejecting liquids in the +z direction from the liquid ejecting head H toward a medium S while transporting the medium S in the x axis direction and reciprocating the liquid ejecting head H in the y axis direction. As for the medium S, it is possible to use an arbitrary material such as cloth, printing paper, and a resin film. Meanwhile, the direction of reciprocation of the liquid ejecting head H is not limited only to the y axis direction but may also be a direction inclined with respect to both of the x axis direction and the y axis direction.

The above-mentioned liquid ejecting apparatus 1 includes the liquid ejecting head H, a liquid reservoir 3, a control unit 4 being a controller, a transportation mechanism 5 that feeds the medium S, and a movement mechanism 6.

The liquid ejecting head H ejects the liquids supplied from the liquid reservoir 3 reserving the liquids in the +z direction as liquid droplets.

The liquid reservoir 3 individually reserves multiple types of liquids having different colors or different components to be ejected from the liquid ejecting head H. Examples of the liquid reservoir 3 include a cartridge that is attachable to and detachable from the liquid ejecting apparatus 1, an ink package in the form of a bag formed from a flexible film, an ink tank that is ink-refillable, and the like. Note that FIG. 1 illustrates a single liquid reservoir 3 as an example. Incidentally, the liquid reservoir 3 may be a liquid reservoir 3 provided with chambers that are divided for individually reserving the multiple types of liquids, or may be formed from two or more liquid reservoirs 3 that are individually provided so as to correspond to the multiple types of liquids. Meanwhile, the liquid reservoir 3 may be divided into a main tank and a sub-tank. This liquid reservoir 3 may be configured to connect the sub-tank to the liquid ejecting head H and to refill the sub-tank with the liquid in the main tank in an amount equivalent to that consumed in the course of ejection of the liquid droplets from the liquid ejecting head H.

The control unit 4 conducts integrated control over the respective elements of the liquid ejecting apparatus 1, namely, the liquid ejecting head H, the transportation mechanism 5, the movement mechanism 6, and so forth.

The transportation mechanism 5 is configured to transport the medium S in the x axis direction and is provided with a transportation roller 5a. The transportation mechanism 5 transports the medium S in the x axis direction by rotating the transportation roller 5a. The transportation roller 5a is rotated by driving a not-illustrated transportation motor. The control unit 4 controls the transportation of the medium S by controlling the drive of the medium transportation motor. Note that the transportation mechanism 5 that transports the medium S is not limited to the one provided with the transportation roller 5a but may instead be configured to transport the medium S by using a belt, a drum, and the like, for example.

The movement mechanism 6 is a mechanism for reciprocating the liquid ejecting head H in the y axis direction, and includes a holding body 7 and a transportation belt 8. The holding body 7 is so-called a carriage that holds the liquid ejecting head H, which is fixed to the transportation belt 8. The transportation belt 8 is an endless belt stretched along the y axis direction. The transportation belt 8 is rotated by driving the not-illustrated transportation motor. The control unit 4 rotates the transportation belt 8 by controlling the drive of the transportation motor, thereby reciprocating the liquid ejecting head H in the y axis direction together with the holding body 7. Here, the holding body 7 may be designed to mount the liquid reservoir 3 together with the liquid ejecting head H.

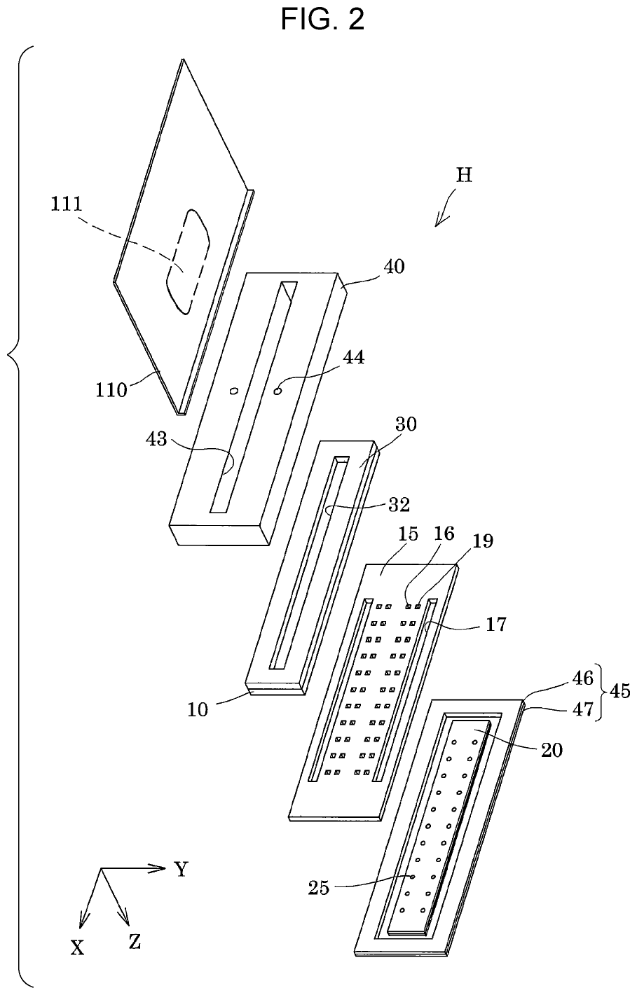

Under the control of the control unit 4, the liquid ejecting head H executes an ejecting action to eject the liquids supplied from the liquid reservoir 3 out of respective nozzles 25 (see FIG. 2) in the +z direction as the liquid droplets. This ejecting action by the liquid ejecting head H is carried out in parallel with the transportation of the medium S by the transportation mechanism 5 and the reciprocation of the liquid ejecting head H by the movement mechanism 6. Thus, application of the liquids onto the medium S, or so-called printing is carried out.

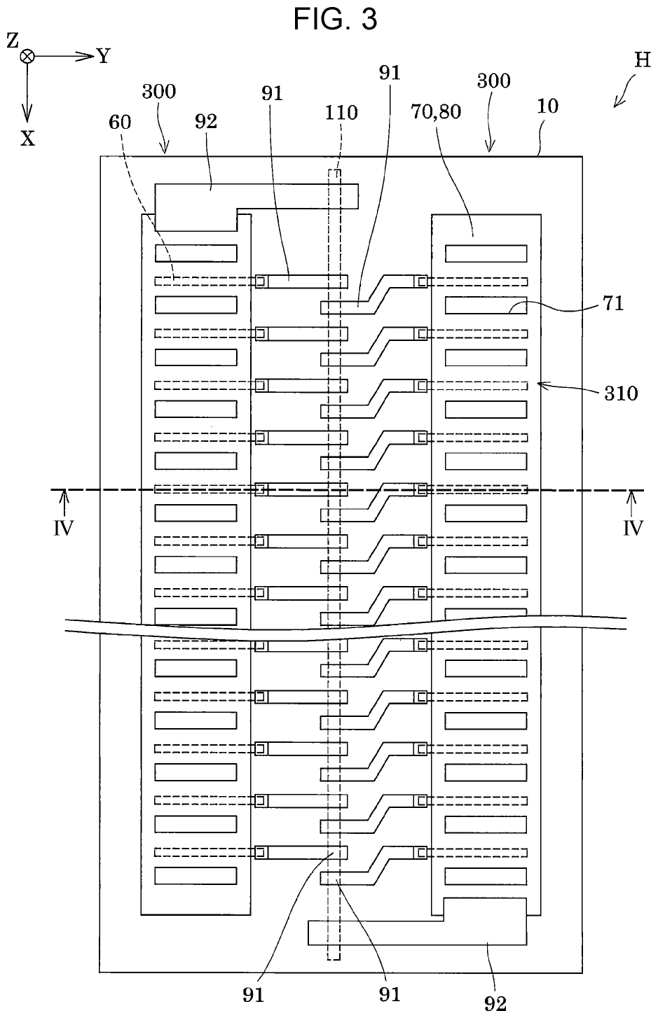

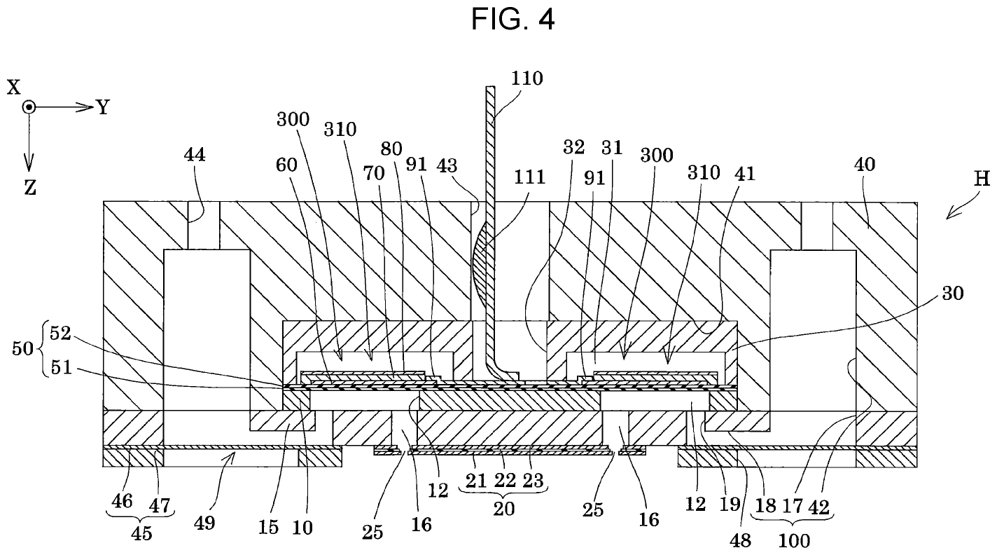

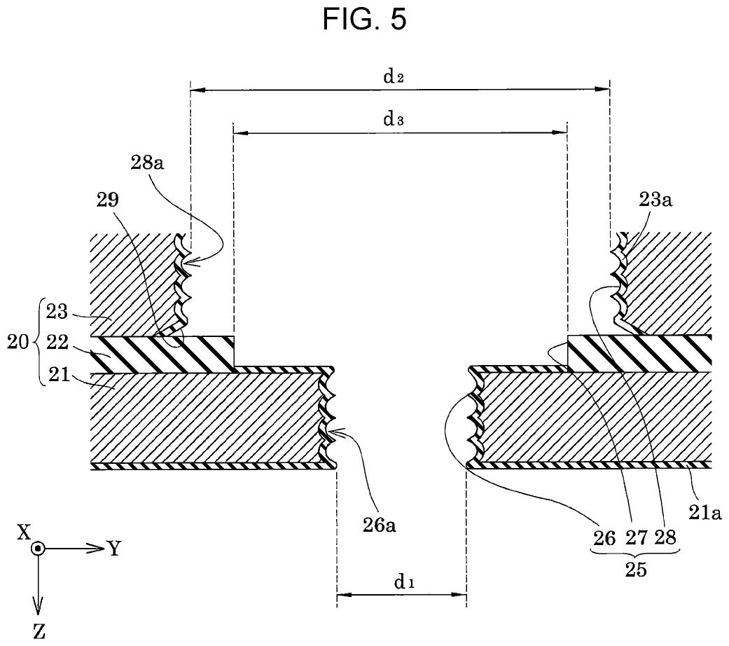

FIG. 2 is an exploded perspective view of the liquid ejecting head H. FIG. 3 is a plan view of a pressure chamber substrate 10 in a state of being embedded in the liquid ejecting head H. FIG. 4 is a cross-sectional view of the liquid ejecting head H taken along the IV-IV line in FIG. 3. FIG. 5 is an enlarged diagram of a main portion of FIG. 4. Note that respective directions of the liquid ejecting head H will be explained based on directions in a state of being mounted on the liquid ejecting apparatus 1, namely, the x axis direction, the y axis direction, and the z axis direction.

As illustrated in FIG. 2, the liquid ejecting head H of the present embodiment includes the pressure chamber substrate 10, a communication plate 15, a nozzle plate 20 provided with the nozzles 25, a protection substrate 30, a case member 40, piezoelectric actuators 300, and a wiring member 110.

The pressure chamber substrate 10 is formed from any of a silicon substrate, a glass substrate, an SOI substrate, and various ceramic substrates, for example. Pressure chambers 12 are disposed at the pressure chamber substrate 10 in arrangement along the x axis direction. The pressure chambers 12 are disposed on a straight line along the x axis direction in such a way as to be located at the same position concerning the y axis direction. Two pressure chambers 12 located adjacent to each other in the x axis direction are partitioned by a not-illustrated partition wall. Meanwhile, in the present embodiment, two pressure chamber lines each formed by arranging the pressure chambers 12 along the x axis direction are provided in the y axis direction. Of course, the layout of the pressure chambers 12 is not limited to this layout in particular. For example, the pressure chambers 12 may be disposed in a staggered manner along the x axis direction. Here, the disposition of the pressure chambers 12 in the staggered manner in the x axis direction means disposition of the pressure chambers 12 that are arranged in the x axis direction in an alternately displaced manner in the y axis direction. Specifically, this means to provide two pressure chamber lines in the y axis direction, each of which is formed by arranging the pressure chambers 12 in the x axis direction, and to dispose the two pressure chamber lines while displacing a half of pitches of the pressure chambers 12 from one another, or by a so-called half pitch in the x axis direction.

The communication plate 15 and the nozzle plate 20 are sequentially laminated on a surface of the pressure chamber substrate 10 oriented to the +z direction. Vibration plates 50 and the piezoelectric actuators 300 are sequentially laminated on a surface of the pressure chamber substrate 10 oriented to the −z direction.

The communication plate 15 is formed from a plate member joined to the surface of the pressure chamber substrate 10 oriented to the +z direction. The communication plate 15 is provided with nozzle communication channels 16 each of which establishes communication between each pressure chamber 12 and the corresponding nozzle 25. Moreover, the communication plate 15 is provided with a first manifold portion 17 and a second manifold portion 18 each constituting a portion of a manifold 100 that forms a common liquid chamber with which the pressure chambers 12 communicate in common. The first manifold portion 17 is provided to penetrate the communication plate 15 in the z axis direction. Meanwhile, the second manifold portion 18 is provided in such a way as to be open to the surface oriented to the +z direction without penetrating the communication plate 15 in the z axis direction. In addition, the communication plate 15 includes supply communication channels 19 each communicating with one end portion in the y axis direction of each of the pressure chambers 12, which are independently provided to the respective pressure chambers 12. Each supply communication channel 19 establishes communication between the second manifold portion 18 and the corresponding pressure chamber 12, thereby supplying the ink in the manifold 100 to the pressure chamber 12. The above-described communication plate 15 can adopt any of a silicon substrate, a glass substrate, an SOI substrate, various ceramic substrates, a metal substrate such as a stainless steel substrate, and so forth. The communication plate 15 preferably uses a material such as a silicon substrate and an SOI substrate, which has a linear expansion coefficient equivalent to that of the substrate to be joined to the relevant communication plate 15, or more specifically, the pressure chamber substrate 10 and the nozzle plate 20. By using the material having the linear expansion coefficient equivalent to that of the substrate to be joined to the communication plate 15, the communication plate 15 can suppress the occurrence of detachment, cracks, and the like due to warpage attributed to a difference in linear expansion coefficient between these materials.

The nozzle plate 20 is joined to the surface of the communication plate 15 on the opposite side from the pressure chamber substrate 10, or in other words, to the surface oriented to the +z direction. The nozzle plate 20 is provided with the nozzles 25 that communicate with the respective pressure chambers 12 through the nozzle communication channels 16. In the present embodiment, the nozzles 25 are disposed in such a way as to be arranged in a line along the x axis direction. Meanwhile, in the present embodiment, two nozzle lines each including the nozzles 25 arranged along the x axis direction are disposed away from each other in the y axis direction. The above-described nozzle plate 20 is formed from the SOI substrate.

As illustrated in FIG. 5, the nozzle plate 20 includes a first nozzle layer 21 formed from silicon, an intermediate layer 22 formed from silicon oxide such as silicon dioxide (SiO₂), and a second nozzle layer 23 formed from silicon. The first nozzle layer 21, the intermediate layer 22, and the second nozzle layer 23 are laminated in this order in the −z direction.

A thickness along the z axis direction of the first nozzle layer 21 is smaller than a thickness of the second nozzle layer 23, and a thickness along the z axis direction of the intermediate layer 22 is smaller than the thickness of the first nozzle layer 21. In other words, the thicknesses along the z axis direction grow larger in the order of the intermediate layer 22, the first nozzle layer 21, and the second nozzle layer 23.

Each nozzle 25 is configured to eject ink droplets in the +z direction, and includes a first nozzle opening 26 formed in the first nozzle layer 21, a space portion 27 formed in the intermediate layer 22, and a second nozzle opening 28 formed in the second nozzle layer 23. The first nozzle opening 26, the space portion 27, and the second nozzle opening 28 are arranged in this order in the −z direction.

Scallops 26a and 28a are formed at side walls of the first nozzle opening 26 and the second nozzle opening 28, respectively. Here, the scallops 26a and 28a each have a corrugated shape such as a shape observed on a surface of a shell, or in other words, a shape provided with multiple recesses to be formed on a side wall of a through hole or a recess when providing a silicon substrate with the through hole or the recess in accordance with a Bosch process. Note that the Bosch process is a method of forming a substantially perpendicular through hole by alternately repeating an etching step and a coating step.

On the other hand, the space portion 27 is not provided with any scallops. In other words, a side wall surface of the space portion 27 is formed into a flat surface extending along the z axis direction.

An inside diameter d₂ of the above-described second nozzle opening 28 is larger than an inside diameter d₁ of the first nozzle opening 26. That is to say, the inside diameter d₁ of the first nozzle opening 26 and the inside diameter d₂ of the second nozzle opening 28 satisfy a relation defined as d₁<d₂. Here, the inside diameter of the first nozzle opening 26 corresponds to the smallest inside diameter of the first nozzle opening 26. For example, when the inside diameter of the first nozzle opening 26 on the intermediate layer 22 side is different from that on an opposite side from the intermediate layer 22, or in other words, when the opening is gradually reduced from the intermediate layer 22 side toward the opposite side from the intermediate layer 22, the inside diameter of the first nozzle opening 26 represents the inside diameter at a portion on the opposite side from the intermediate layer 22. In the meantime, while the scallop is formed on the side wall of the first nozzle opening 26, the inside diameter of the first nozzle opening 26 corresponds to the inside diameter at the smallest portion generated by the scallop. Nonetheless, the inside diameter of the first nozzle opening 26 may be the largest inside diameter or an average value of the inside diameters measured at several locations in terms of a depth direction. The principle on the inside diameter d₁ of the first nozzle opening 26 also applies to the inside diameter d₂ of the second nozzle opening 28 likewise.

An inside diameter d₃ of the space portion 27 is larger than the inside diameter d₁ of the first nozzle opening 26 and smaller than the inside diameter d₂ of the second nozzle opening 28. That is to say, the inside diameter d₁ of the first nozzle opening 26, the inside diameter d₂ of the second nozzle opening 28, and the inside diameter d₃ of the space portion 27 satisfy a relation defined as d₁<d₃ <d₂. The above-described nozzle 25 is designed to reduce the inside diameters of the second nozzle opening 28, the space portion 27, and the first nozzle opening 26 in this order so as to suppress formation of a location where a bubble or the ink is retained inside the nozzle 25 by reducing the inside diameters stepwise toward the direction of a flow of the ink. As a consequence, it is possible to suppress displacement of a landing position of an ink droplet on the medium S due to bending of the ejecting direction of the ink droplet, the occurrence of an ejection failure due unsuccessful ejection of an ink droplet, and the like caused by the retention of the bubble inside the nozzle 25.

Meanwhile, the second nozzle layer 23 is provided with a groove 29 which is open on a wall surface of the second nozzle opening 28 at an interface with the intermediate layer 22. Although details will be described later, this groove 29 is formed by notching that occurs in the course of formation of the second nozzle opening 28 in the second nozzle layer 23 by etching. Here, notching means a phenomenon that occurs in the case of forming a through hole from one surface side of a silicon substrate by means of etching while causing an insulating film provided on another surface side of the silicon substrate to function as an etching stop layer, in which the insulating film having been charged accordingly bends ions used for the etching, thereby forming a groove by widely etching a portion on the insulating film side of a side wall of the through hole.

Although the second nozzle layer 23 is assumed to be provided with the groove 29 in the present embodiment, notching does not always occur in the course of formation of the second nozzle opening 28, and the groove 29 is not always formed every time. This is due to the following reason. When the second nozzle opening 28 is formed in the second nozzle layer 23 by etching, there are a portion having a large etching rate and a portion having a small etching rate within the plane of the second nozzle layer 23. Accordingly, over-etching is carried out to some extent so as to avoid the development of an unpenetrated portion within the second nozzle opening 28. In this instance, the portion having the large etching rate is penetrated fast and is more likely to develop notching while the portion having the small etching rate does not cause notching or is less likely to cause notching. In other words, there may be a case where the groove 29 is formed entirely in a circumferential direction of the second nozzle opening 28 or a case where the groove 29 is formed fragmentally in the circumferential direction. There may also be case where the groove 29 is not formed at all.

In the meantime, the first nozzle layer 21 is not provided with a groove which is open on a wall surface of the first nozzle opening 26 at an interface with the intermediate layer 22. Although details will be described later, this is because notching does not occur in the course of formation of the first nozzle opening 26 in the first nozzle layer 21 by etching thanks to the existence of the space portion 27.

As described above, since the groove due to notching is not formed at a boundary of the first nozzle opening 26 with the intermediate layer 22, it is possible to provide the first nozzle opening 26 with substantially the equal opening area across the z axis direction. Accordingly, the occurrence of a variation in ejection characteristics of the ink droplets ejected from the nozzle 25 can be suppressed by stabilizing the shape of the first nozzle opening 26.

Meanwhile, the groove 29 is formed at a boundary of the second nozzle opening 28 with the intermediate layer 22. Accordingly, even if an extra adhesive used for attaching the nozzle plate 20 to the communication plate 15 with the adhesive flows into the second nozzle opening 28, it is possible to prevent the adhesive from flowing to the first nozzle opening 26 side by transferring the adhesive to the groove 29. In other words, the groove 29 functions as an adhesive transfer groove. As described above, by allowing the extra adhesive to flow into the groove 29, it is possible to avoid a change in shape of the first nozzle opening 26 due to a flow of the adhesive into the first nozzle opening 26, and to suppress the occurrence of a variation in ejection characteristics of the ink droplets due to the adhesive. Here, dominant parameters for determining the ejection characteristics of the ink droplets include the dimension d₁ and a depth in the z axis direction of the first nozzle opening 26. Accordingly, even when the groove 29 is formed at the boundary of the second nozzle opening 28 with the intermediate layer 22, the ejection characteristics of the ink droplets are not significantly affected unless the first nozzle opening 26 is provided with a groove formed by notching.

Here, protection films 21a and 23a made of silicon oxide or the like are formed on exposed surfaces of the first nozzle layer 21 and the second nozzle layer 23. Specifically, the protection film 21a is formed on the surface of the first nozzle layer 21 oriented to the +z direction, on the side wall surface of the first nozzle opening 26, and on a surface of the first nozzle layer 21 exposed by the space portion 27. Meanwhile, the protection film 23a is formed on the surface of the second nozzle layer 23 oriented to the −z direction, on the side wall surface of the second nozzle opening 28, and on an inner surface of the groove 29. In other words, the first nozzle opening 26 and the second nozzle opening 28 are actually formed on inner sides of the protection films 21a and 23a. While a material of the above-described protection films 21a and 23a is not limited to a particular material, silicon oxide and the like formed by subjecting silicon to thermal oxidation may be used as this material, for example. Of course, the protection films 21a and 23a may be formed in accordance with a method other than thermal oxidation, and the material is not limited only to silicon oxide. In the meantime, when the protection films 21a and 23a are formed in accordance with a method other than thermal oxidation, a protection film may also be formed on the surface of the intermediate layer 22.

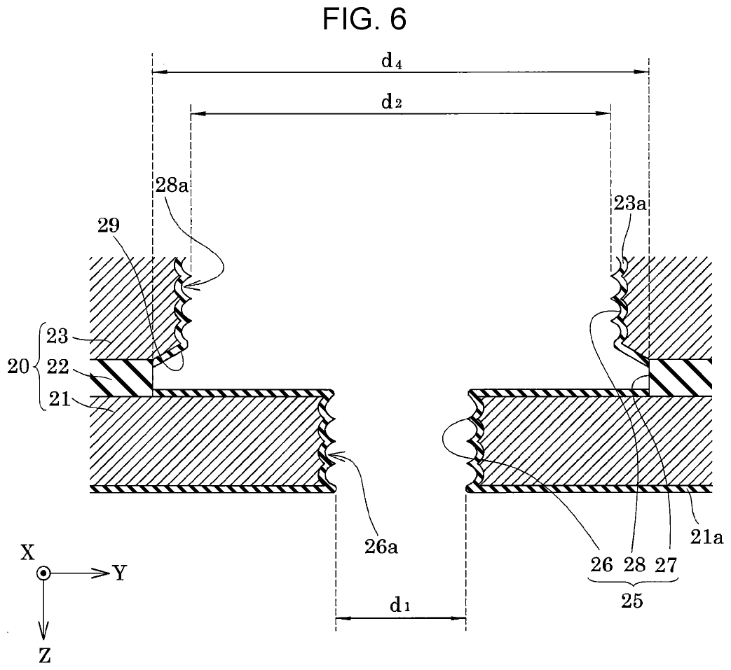

Meanwhile, the shape of the nozzle 25 is not limited to the above-mentioned shape in particular. Now, modified examples of the nozzle 25 will be illustrated in FIGS. 6 to 8. FIGS. 6 to 8 are cross-sectional views illustrating modified examples of the nozzle 25 according to the Embodiment 1 of the present disclosure.

As illustrated in FIG. 6, an inside diameter d₄ of the space portion 27 is larger than the inside diameter d₂ of the second nozzle opening 28. That is to say, the inside diameter d₄ of the space portion 27 and the inside diameter d₂ of the second nozzle opening 28 satisfy a relation defined as d₄>d₂. By setting the inside diameter d₄ of the space portion 27 larger than the inside diameter d₂ of the second nozzle opening 28 as described above, the side wall of the space portion 27 is formed on an outer side of the side wall of the second nozzle opening 28. In other words, the space portion 27 forms a recess between the side wall of the second nozzle opening 28 and the side wall of the first nozzle opening 26. By forming the recess while using the space portion 27 as described above, foreign matters included in the ink flowing in from the second nozzle opening 28 are trapped by the space portion 27, so that the first nozzle opening 26 can be kept from clogging by the foreign matters while reducing the foreign matters that would be directed to the first nozzle opening 26. Moreover, by providing the space portion 27 in the form of the recess, even if an extra adhesive used for attaching the nozzle plate 20 to the communication plate 15 with the adhesive flows into the second nozzle opening 28, it is possible to prevent the adhesive from flowing to the first nozzle opening 26 side by transferring the adhesive into the space portion 27. In other words, the space portion 27 also functions as the adhesive transfer groove. As described above, by allowing the extra adhesive to flow into the space portion 27, it is possible to avoid a change in shape of the first nozzle opening 26 due to the flow of the adhesive into the first nozzle opening 26, and to suppress the occurrence of a variation in ejection characteristics of the ink droplets due to the adhesive.

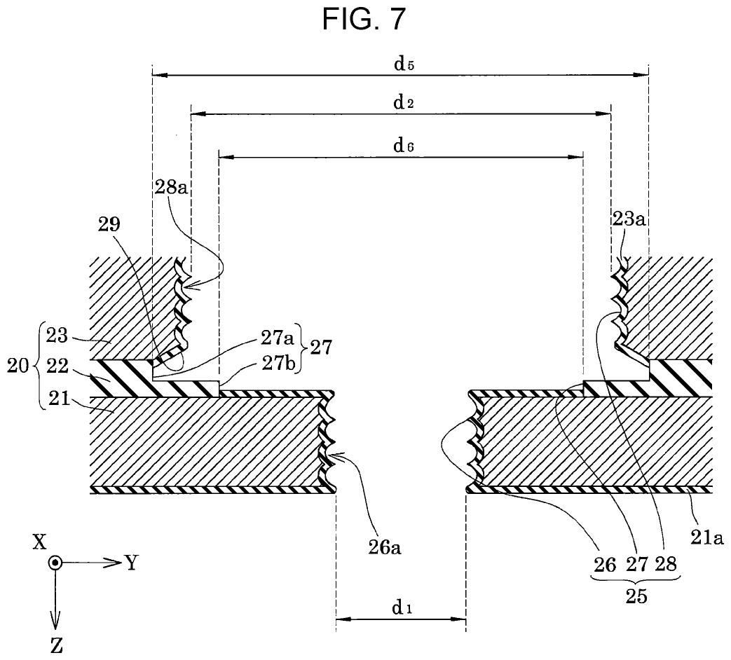

Meanwhile, as illustrated in FIG. 7, the space portion 27 includes a first portion 27a located on the second nozzle opening 28 side, and a second portion 27b located on the first nozzle opening 26 side and having a smaller inside diameter than that of the first portion 27a. An inside diameter d₅ of the first portion 27a is larger than the inside diameter d₂ of the second nozzle opening 28, and an inside diameter d₆ of the second portion 27b is smaller than the inside diameter d₂ of the second nozzle opening 28. That is to say, the inside diameter d₅ of the first portion 27a, the inside diameter d₆ of the second portion 27b, and the inside diameter d₂ of the second nozzle opening 28 satisfy a relation defined as d₅>d₂>d₆. In the meantime, each of the inside diameter d₅ of the first portion 27a and the inside diameter d₆ of the second portion 27b is larger than the inside diameter d₁ of the first nozzle opening 26. That is to say, the inside diameter d₅ of the first portion 27a, the inside diameter d₆ of the second portion 27b, the inside diameter d₁ of the first nozzle opening 26, and the inside diameter d₂ of the second nozzle opening 28 satisfy a relation defined as d₅>d₂>d₆>d₁. Even in the configuration in which the space portion 27 includes the first portion 27a and the second portion 27b as described above, the first portion 27a forms a recess between the side wall of the second nozzle opening 28 and a side wall of the second portion 27b by using the first portion 27a as with the above-described case in FIG. 6. Accordingly, foreign matters included in the ink can be trapped by the recess formed by the first portion 27a between the side walls of the first nozzle opening 26 and the second nozzle opening 28, so that the first nozzle opening 26 can be kept from clogging by the foreign matters. Meanwhile, by allowing the extra adhesive to flow into the recess formed at the first portion 27a, it is possible to avoid a change in shape of the first nozzle opening 26 by the adhesive. Moreover, since the inside diameters can be reduced stepwise in the order of the second nozzle opening 28, the second portion 27b, and the first nozzle opening 26, the flow of the ink is hardly blocked.

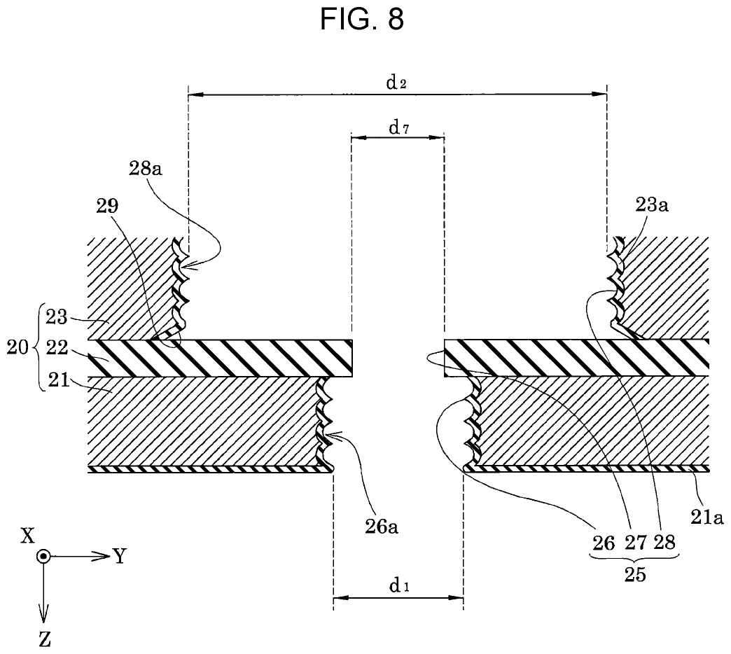

In the meantime, as illustrated in FIG. 8, an inside diameter d₇ of the space portion 27 is smaller than the inside diameter d₂ of the second nozzle opening 28 and is smaller than the inside diameter d₁ of the first nozzle opening 26. That is to say, the inside diameter d₇ of the space portion 27, the inside diameter d₁ of the first nozzle opening 26, and the inside diameter d₂ of the second nozzle opening 28 satisfy a relation defined as d₂>d₁>d₇. By forming the inside diameter d₇ of the space portion 27 smaller than the inside diameter d₁ of the first nozzle opening 26 as described above, even if foreign matters flow in from the first nozzle opening 26, the intermediate layer 22 that projects inward relative to the first nozzle opening 26 can keep the foreign matters from moving to the second nozzle opening 28 side.

In the present embodiment, each vibration plate 50 includes an elastic film 51 provided on the pressure chamber substrate 10 side and made of silicon oxide, and an insulating film 52 provided on a surface of the elastic film 51 oriented to the −z direction and made of zirconium oxide. Here, the vibration plate 50 may consist of the elastic film 51, consist of the insulating film 52, or adopt a structure including another film in addition to the elastic film 51 and the insulating film 52.

Each piezoelectric actuator 300 includes a first electrode 60, a piezoelectric layer 70, and a second electrode 80, which are sequentially laminated toward the −z direction on the vibration plate 50. The above-mentioned piezoelectric actuator 300 is also referred to as a piezoelectric element, which corresponds to a portion including the first electrode 60, the piezoelectric layer 70, and the second electrode 80. Meanwhile, a portion of the piezoelectric layer 70 where piezoelectric strain occurs in a case of applying a voltage between the first electrode 60 and the second electrode 80 will be referred to as an activated portion 310. On the other hand, a portion of the piezoelectric layer 70 where the piezoelectric strain does not occur will be referred to as an inactivated portion. Specifically, the activated portion 310 corresponds to the portion of the piezoelectric layer 70 interposed between the first electrode 60 and the second electrode 80. In the present embodiment, the activated portion 310 is provided to each of the pressure chambers 12. That is to say, the piezoelectric actuator 300 is provided with multiple activated portions 310. These activated portions 310 serve as drive elements that create changes in pressure of inks inside the pressure chambers 12. Moreover, one of electrodes of each activated portion 310 is generally formed as an individual electrode that is independently provided to each activated portion 310 while the other electrode is formed as a common electrode that is common to the activated portions 310. In the present embodiment, the first electrode 60 forms the individual electrode while the second electrode 80 forms the common electrode. Of course, the first electrode 60 may form the common electrode and the second electrode 80 may form the individual electrode instead.

As illustrated in FIG. 3, the first electrodes 60 are divided corresponding to the respective pressure chambers 12 and constitute the individual electrodes independently provided to the respective activated portions 310. As illustrated in FIGS. 3 and 4, the piezoelectric layer 70 is continuously provided across the x axis direction at a predetermined width in the y axis direction. Moreover, the piezoelectric layer 70 is provided with recesses 71 at positions not overlapping the first electrodes 60 as illustrated in FIG. 3. Nevertheless, the recesses 71 do not always have to be provided. The above-described piezoelectric layer 70 is formed by using a piezoelectric material made of a compound oxide having a perovskite structure expressed by a general formula ABO₃, for example. As illustrated in FIGS. 3 and 4, the second electrode 80 is continuously provided on the −z direction side of the piezoelectric layer 70 being an opposite side from the first electrodes 60, thus constituting the common electrode that is common to the activated portions 310. The second electrode 80 is continuously provided across the x axis direction in such a way as to have a predetermined width in the y axis direction.

Meanwhile, an individual lead electrode 91 serving as lead-out wiring is led out of each first electrode 60. Meanwhile, a common lead electrode 92 serving as lead-out wiring is led out of the second electrode 80. The wiring member 110 formed from a flexible substrate having flexibility is connected to end portions of these individual lead electrodes 91 and of the common lead electrode 92 on opposite sides of end portions thereof connected to the piezoelectric actuators 300. A drive signal selection circuit 111, which includes switching elements used for selecting whether or not to supply a drive signal COM for driving the respective activated portions 310 to each of the activated portions 310, is mounted on the wiring member 110. That is to say, the wiring member 110 of the present embodiment is a chip on film (COF). Here, the wiring member 110 does not always have to be provided with the drive signal selection circuit 111. In other words, the wiring member 110 may be any of a flexible flat cable (FFC), flexible printed circuits (FPC), and the like.

As illustrated in FIGS. 2 and 4, the protection substrate 30 having substantially the same size as that of the pressure chamber substrate 10 is joined to a surface of the pressure chamber substrate 10 which is oriented to the −z direction. The protection substrate 30 includes housing portions 31 being spaces for protecting the piezoelectric actuators 300. The housing portions 31 are independently provided to the respective lines of the piezoelectric actuators 300 disposed in arrangement in the x axis direction, and two housing portions 31 are formed in arrangement in the y axis direction. Moreover, the protection substrate 30 is provided with a through hole 32 that penetrates the protection substrate 30 in the z axis direction at a position between the two housing portions 31 disposed in arrangement in the y axis direction. The end portions of the individual lead electrodes 91 and of the common lead electrode 92 led out of the electrodes of the piezoelectric actuators 300 extend in such a way as to be exposed in this through hole 32, and the individual lead electrodes 91 and the common lead electrode 92 are electrically connected to the wiring member 110 in the through hole 32. The above-described protection substrate 30 employs any of a silicon substrate, a glass substrate, an SOI substrate, various ceramic substrates, and so forth as with the pressure chamber substrate 10, for example.

Meanwhile, the case member 40 that defines the manifold 100 communicating with the pressure chambers 12 in conjunction with the pressure chamber substrate 10 is fixed onto the protection substrate 30. The case member 40 has substantially the same shape as that of the above-mentioned communication plate 15 in plan view. The case member 40 is joined to the protection substrate 30 and is also joined to the above-mentioned communication plate 15. The above-described case member 40 has a recess 41 on the protection substrate 30 side having such a depth that houses the pressure chamber substrate 10 and the protection substrate 30. Meanwhile, the case member 40 is provided with a third manifold portion 42 that communicates with the first manifold portion 17 of the communication plate 15. Moreover, the first manifold portion 17 and the second manifold portion 18 provided to the communication plate 15, and the third manifold portion 42 provided to the case member 40 collectively constitute the manifold 100 of the present embodiment. The manifold 100 is provided to each line of the pressure chambers 12. That is to say, two manifolds 100 are provided in total. Each manifold 100 is continuously provided across the x axis direction in which the pressure chambers 12 are disposed in arrangement, while the supply communication channels 19 that establish communication between the respective pressure chambers 12 and the manifold 100 are disposed in arrangement in the x axis direction. In the meantime, the case member 40 is provided with inlet ports 44 for communicating with the manifolds 100 and supplying the inks to the respective manifolds 100. Moreover, the case member 40 is provided with a connection port 43, which communicates with the through hole 32 of the protection substrate 30 and to which the wiring member 110 is inserted. The wiring member 110 is led out to the surface side of the liquid ejecting head H oriented to the −z direction through the connection port 43. A metal material, a resin material, and the like can be used for the case member 40.

Meanwhile, a compliance substrate 45 is provided on a surface of the communication plate 15 on the +z direction side where the first manifold portion 17 and the second manifold portion 18 are open. This compliance substrate 45 seals openings on the +z direction side of the first manifold portion 17 and of the second manifold portion 18. In the present embodiment, the above-described compliance substrate 45 includes a sealing film 46 formed from a flexible thin film, and a fixation substrate 47 formed from a hard material such as a metal. A region of the fixation substrate 47 opposed to each manifold 100 is formed into an opening 48 that is completely removed in a thickness direction. Accordingly, a surface on one side of the manifold 100 is formed into a compliance portion 49 being a flexible portion sealed only with the sealing film 46 having flexibility.

In the above-described liquid ejecting head H, the ink is taken in from each inlet port 44 and the inside of the flow channel that extends from the manifold 100 to the nozzles 25 is filled with the ink. Thereafter, the vibration plates 50 as well as the piezoelectric actuators 300 are flexurally deformed by applying voltages to the respective activated portions 310 corresponding to the pressure chambers 12 in accordance with signals from the drive signal selection circuit 111. Thus, pressures of the inks inside the pressure chambers 12 are increased and ink droplets are ejected from predetermined nozzles 25.

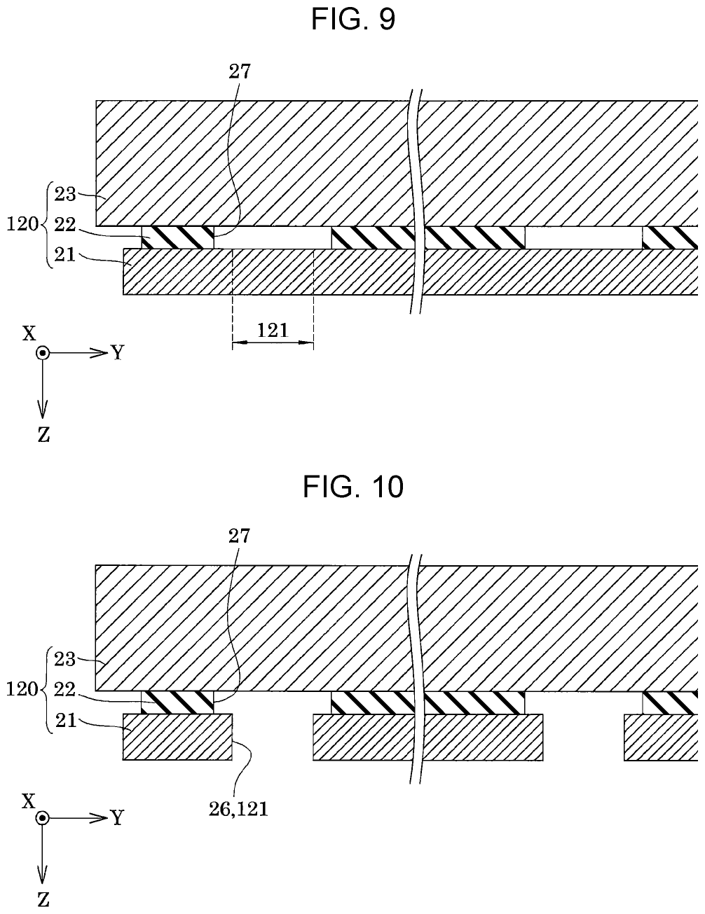

A method of manufacturing the nozzle plate 20 of the liquid ejecting head H of the present embodiment will be described with reference to FIGS. 9 to 15. Note that FIGS. 9 to 15 are cross-sectional views illustrating the method of manufacturing the nozzle plate.

A first step of preparing a substrate 120 is carried out to begin with. As illustrated in FIG. 9, the substrate 120 is prepared by laminating the first nozzle layer 21 formed from silicon, the intermediate layer 22 formed from silicon oxide, and the second nozzle layer 23 formed from silicon in this order toward the −z direction, and then forming the space portion 27 at a portion of the intermediate layer 22.

The substrate 120 is formed from a so-called SOI substrate. That is to say, in the first step, an oxide film is formed across the surface of the second nozzle layer 23 by subjecting the surface of the second nozzle layer 23 to oxidation to in the first place. Subsequently, the oxide film is patterned into a predetermined shape in accordance with a lithography method so as to form the intermediate layer 22 provided with the space portion 27. Thereafter, the substrate 120 is formed by attaching the second nozzle layer 23 provided with the intermediate layer 22 to the first nozzle layer 21. Here, the space portion 27 of the intermediate layer 22 is formed in advance such that the inside diameter d₃ thereof becomes smaller than the inside diameter d₂ of the second nozzle opening 28 as illustrated in FIG. 5. Meanwhile, since the intermediate layer 22 is subjected to etching in a subsequent step, the inside diameter thereof is preferably formed smaller than the inside diameter d₃ in advance. Meanwhile, as illustrated in FIG. 8, the space portion 27 may be formed into the inside diameter d₇ that is smaller than the inside diameter d₁ of the first nozzle opening 26. Here, if it is possible to prepare the SOI substrate provided with the space portion 27 at a portion of the intermediate layer 22, then the first step does not have to be the above-described manufacturing process. For example, the surface of the first nozzle layer 21 may be oxidized instead of the second nozzle layer 23. Alternatively, the SOI substrate provided with the space portion 27 at a portion of the intermediate layer 22 may be procured from outside.

Next, a second step of providing the first nozzle opening 26 that communicates with the space portion 27 is carried out. Here, a first region 121 (see FIG. 9) where at least a portion of the first nozzle layer 21 overlaps the space portion 27 is subjected to the Bosch process as illustrated in FIG. 10. In the present embodiment, the second step is carried out by conducting the Bosch process from a surface of the first nozzle layer 21 on an opposite side from the intermediate layer 22, or in other words, from a surface of the first nozzle layer 21 oriented to the +z direction. In this Bosch process of forming the first nozzle opening 26, notching attributable to the charged intermediate layer 22 does not occur since the intermediate layer 22 is provided with the space portion 27. This is due to the following reason. Specifically, a surface of the second nozzle layer 23 oriented to the +z direction is etched after penetration of the first nozzle layer 21, and no ions will remain between the first nozzle opening 26 and the intermediate layer 22. In other words, the groove due to notching is not formed at the boundary of the first nozzle opening 26 with the intermediate layer 22. Incidentally, if the intermediate layer 22 is not provided with the space portion 27, notching will occur when the first nozzle opening 26 is formed in the first nozzle layer 21 by conducting the Bosch process, and a groove will possibly be formed at the boundary of the first nozzle opening 26 with the intermediate layer 22. In the present embodiment, the intermediate layer 22 is provided with the space portion 27 in advance, so that the occurrence of notching can be suppressed when forming the first nozzle opening 26, and formation of the groove at the boundary of the first nozzle opening 26 with the intermediate layer 22 can also be suppressed. Thus, it is possible to form the first nozzle opening 26 into a desired shape, and to suppress the occurrence of adverse effects on the ejection characteristics due to a shape defect of the first nozzle opening 26.

Next, a fourth step of forming an oxide film 122 in such a way as to cover at least the first nozzle opening 26 of the first nozzle layer 21 is carried out as illustrated in FIG. 11 after the second step. In the present embodiment, the fourth step is carried out by oxidizing the entire substrate 120 so as to form the oxide film 122 on a surface of the first nozzle layer 21 not covered with the intermediate layer 22, that is to say, an exposed surface of the first nozzle layer 21 inclusive of the side wall surface of the first nozzle opening 26, and then forming an oxide film 123 on a surface of the second nozzle layer 23 not covered with the intermediate layer 22.

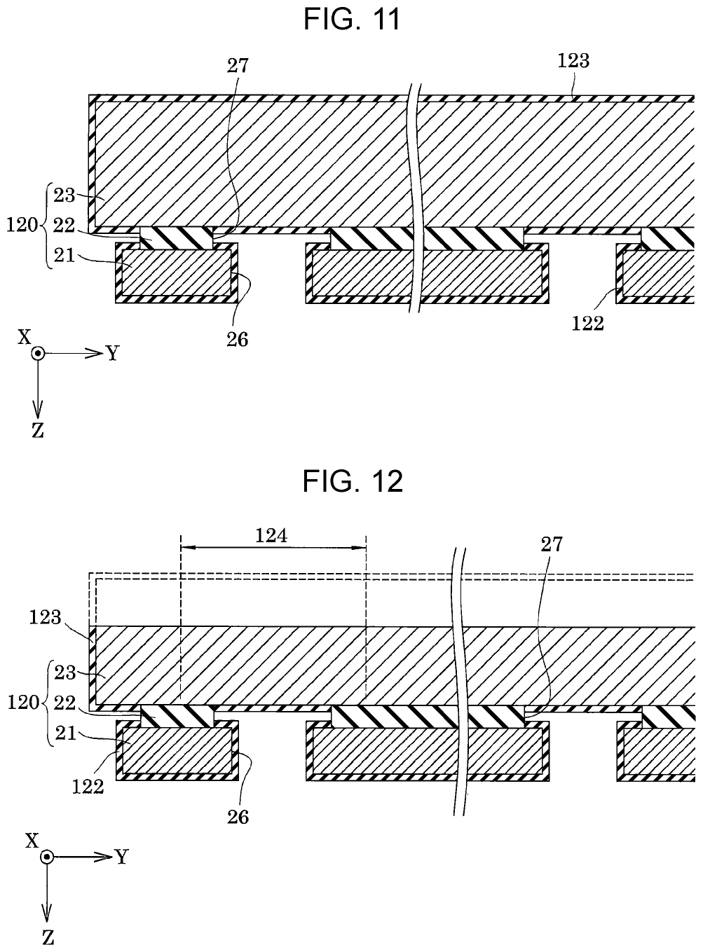

Then, a fifth step of thinning the second nozzle layer 23 of the substrate 120 is carried out as illustrated in FIG. 12 after the fourth step. The fifth step is carried out by grinding and polishing the second nozzle layer 23 from an opposite side of the intermediate layer 22 of the second nozzle layer 23, that is to say, from a surface side oriented to the −z direction in accordance with chemical mechanical polishing (CMP) and the like. Here, thinning of the second nozzle layer 23 in the fifth step is not limited to grinding and polishing. For example, the second nozzle layer 23 may be thinned by etching instead.

Next, a third step of providing the second nozzle opening 28 that communicates with the space portion 27 by conducting the Bosch process on a second region 124 (see FIG. 12) where at least a portion of the second nozzle layer 23 overlaps the space portion 27 is carried out as illustrated in FIG. 13. In the present embodiment, the third step is carried out by conducting the Bosch process from the surface of the second nozzle layer 23 on the opposite side of the intermediate layer 22, that is to say, from the surface of the second nozzle layer 23 oriented to the −z direction. In this Bosch process of forming second the second nozzle opening 28, the oxide film 123 functions as an etching stop layer. Accordingly, notching attributable to the charged oxide film 123 occurs and the groove 29 is formed at the boundary of the second nozzle opening 28 with the intermediate layer 22. Even though the groove 29 is formed at the boundary of the second nozzle opening 28 with the intermediate layer 22 as mentioned above, this does not significantly affect the ejection characteristics of the ink droplets unless such a groove is formed at the first nozzle opening 26. Meanwhile, the first nozzle layer 21 is covered with the oxide film 122 by carrying out the third step after the fourth step. Accordingly, the first nozzle layer 21 can be kept from being etched simultaneously in the course of forming the second nozzle layer 23 in the third step.

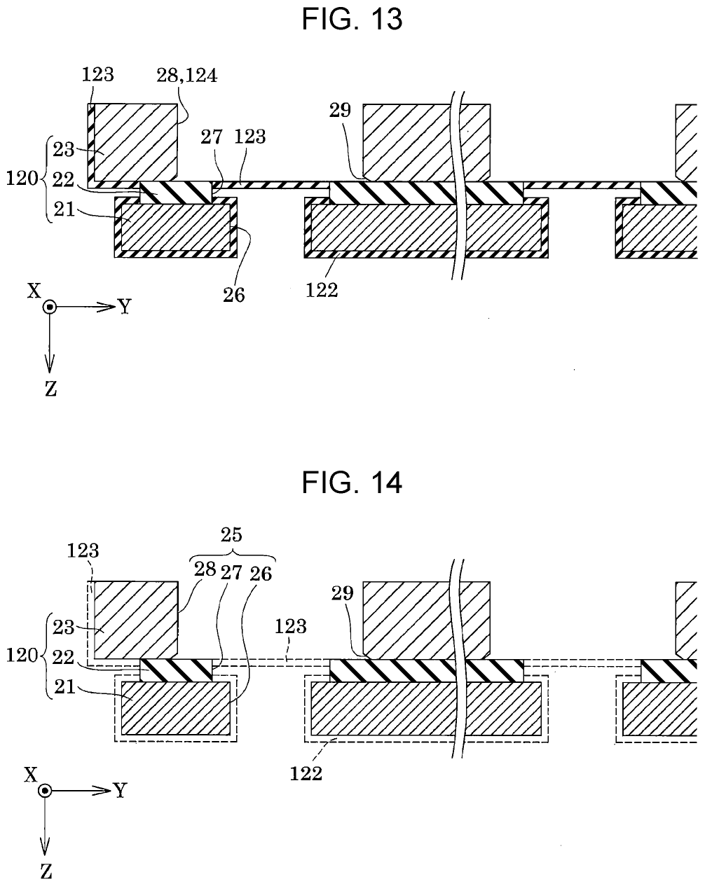

Then, the oxide films 122 and 123 on the substrate 120 are removed as illustrated in FIG. 14. In the present embodiment, the oxide film 122 on the first nozzle layer 21 and the oxide film 123 on the second nozzle layer 23 are removed by etching with hydrofluoric acid and the like. Thus, the oxide film 123 partitioning between the first nozzle opening 26 and the second nozzle opening 28 is removed and the first nozzle opening 26 communicates with the second nozzle opening 28 through the space portion 27. Note that a portion of the intermediate layer 22 formed from silicon oxide is also removed in this step in the course of removing the oxide films 122 and 123 by etching. Accordingly, adjustment of an etching period makes it possible to form the inside diameter d₃ of the space portion 27 smaller than the inside diameter d₂ of the second nozzle opening 28 as illustrated in FIG. 5, and to form the inside diameter d₄ of the space portion 27 larger than the inside diameter d₂ of the second nozzle opening 28 as illustrated in FIG. 6, for example. Here, it is also possible to form the space portion 27 provided with the first portion 27a and the second portion 27b as illustrated in FIG. 7 by suspending etching in the middle of obtaining the state illustrated in FIG. 6 when forming the space portion 27. Incidentally, in the present embodiment, the inside diameter d₃ of the space portion 27 is formed into such an inside diameter that is larger than the inside diameter d₁ of the first nozzle opening 26 and smaller than the inside diameter d₂ of the second nozzle opening 28 in the first step. However, the present disclosure is not limited to this configuration. For example, when the inside diameter d₇ of the space portion 27 is formed smaller than the inside diameter d₁ of the first nozzle opening 26 as illustrated in FIG. 8 in the first step, it is possible to form any of the space portions 27 illustrated in FIGS. 5 to 8 by adjusting the etching period in the step illustrated in FIG. 14. The manufacturing method of the present embodiment exemplifies the drawing in which the space portion 27 illustrated in FIG. 5 is formed.

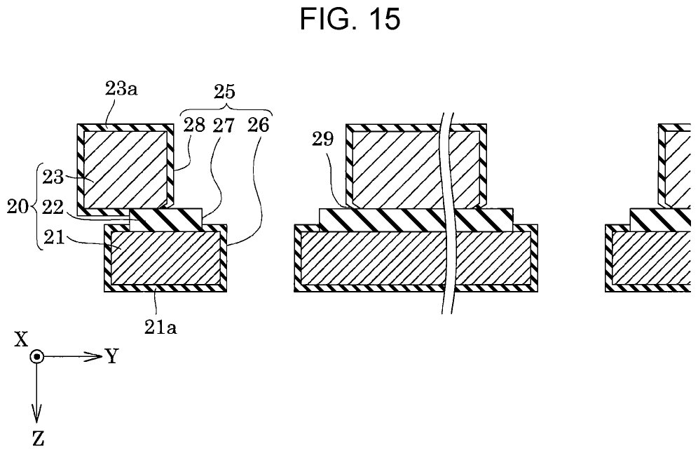

Next, the first nozzle layer 21 is provided with the protection film 21a and the second nozzle layer 23 is provided with the protection film 23a as illustrated in FIG. 15. In the present embodiment, the protection films 21a and 23a are simultaneously provided to the first nozzle layer 21 and the second nozzle layer 23 by oxidizing the entire substrate 120. In this way, the nozzle plate 20 of the present embodiment is manufactured.

As described above, according to the method of manufacturing the nozzle plate 20 of the present embodiment, the groove is not formed due to notching at the boundary on the intermediate layer 22 side of the first nozzle opening 26. It is therefore possible to form the shape of the first nozzle opening 26 stably. Meanwhile, since it is possible to manage a length in the z axis direction of the first nozzle opening 26 by using the thickness of the first nozzle layer 21, the first nozzle opening 26 can be formed at a highly accurate length as compared to the case of adjustment by the etching period. Accordingly, it is possible to suppress the occurrence of a variation in ejection characteristics of the ink due to unstable shapes of the nozzles 25, and thus to suppress the occurrence of a variation in printing quality.

### Embodiment 2

FIG. 16 is a cross-sectional view of a main portion of the nozzle plate 20 according to Embodiment 2. Note that the same constituents as those in the above-described Embodiment 1 will be denoted by the same reference signs and overlapping explanations thereof will be omitted.

As with the above-described Embodiment 1, the nozzle plate 20 of the present embodiment is formed from the SOI substrate including the first nozzle layer 21, the intermediate layer 22, and the second nozzle layer 23.

Each nozzle 25 includes the first nozzle opening 26, the space portion 27, and the second nozzle opening 28. An inside diameter d₈ of the space portion 27 is substantially equal to the inside diameter d₁ of the first nozzle opening 26 or slightly larger than the inside diameter d₁ of the first nozzle opening 26 in an amount equivalent to the protection film 21a.

Meanwhile, the inside diameter d₈ of the space portion 27 is smaller than the inside diameter d₂ of the second nozzle opening 28.

The scallops 26a and 28a are formed at the side walls of the first nozzle opening 26 and the second nozzle opening 28, respectively. On the other hand, the side wall of the space portion 27 is not provided with any scallops, and is formed into a flat surface extending along the z axis direction.

In the meantime, the groove due to notching is not formed at the boundary of the second nozzle opening 28 with the intermediate layer 22. The groove due to notching is not formed at the boundary of the first nozzle opening 26 with the intermediate layer 22.

According to the above-described nozzle 25, it is possible to form the first nozzle opening 26 and the second nozzle opening 28 into desired shapes at high accuracy since the groove due to notching is not formed at the first nozzle opening 26 or the second nozzle opening 28.

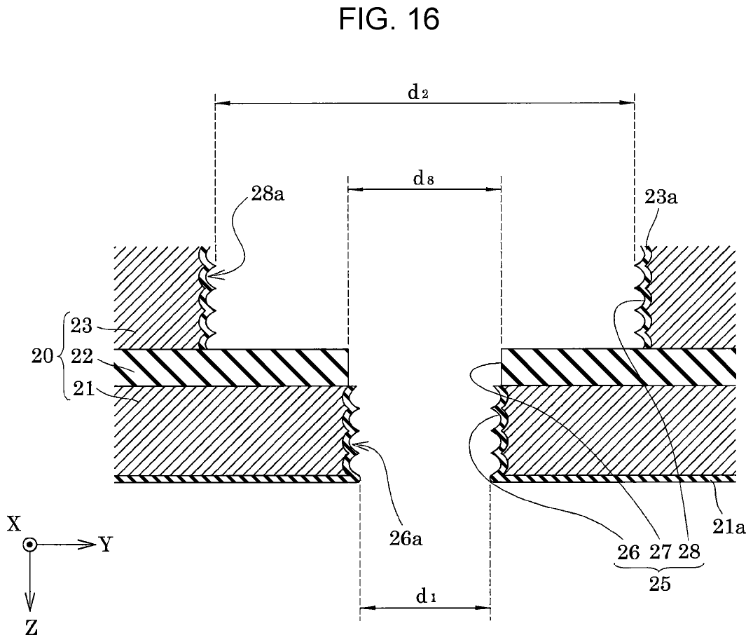

A method of manufacturing the above-described nozzle plate 20 will be described with reference to FIGS. 17 to 20. Note that FIGS. 17 to 20 are cross-sectional views illustrating the method of manufacturing the nozzle plate 20 according to the Embodiment 2.

The first step of preparing the substrate 120 is carried out to begin with. As illustrated in FIG. 17, the substrate 120 is prepared by laminating the first nozzle layer 21 formed from silicon, the intermediate layer 22 formed from silicon oxide, and the second nozzle layer 23 formed from silicon in this order toward the −z direction, and then forming the space portion 27 at a portion of the intermediate layer 22.

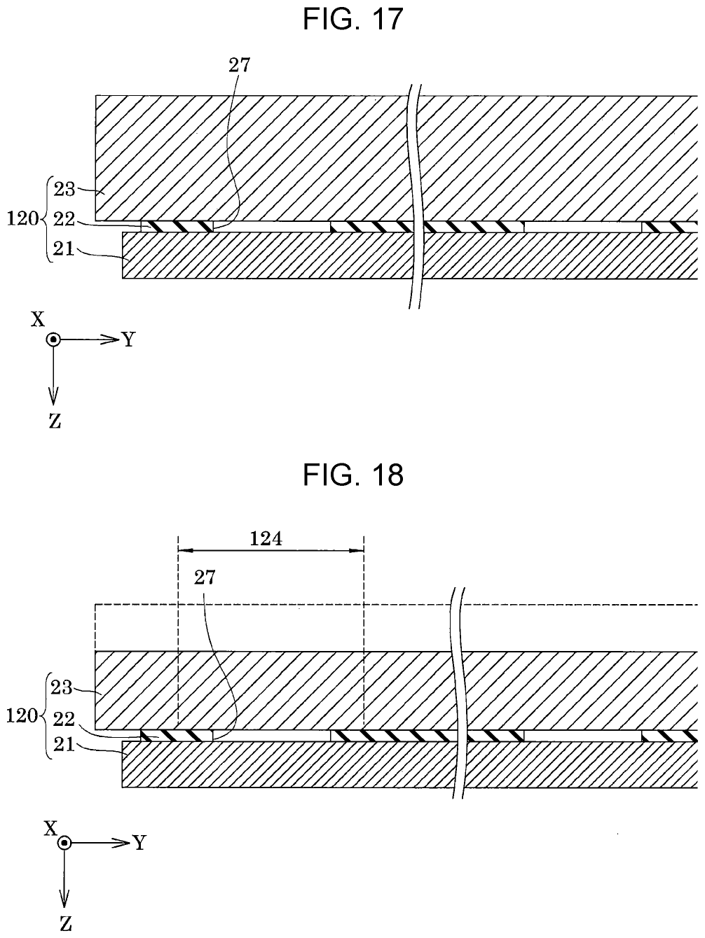

Next, the fifth step of thinning the second nozzle layer 23 of the substrate 120 is carried out as illustrated in FIG. 18 after the first step.

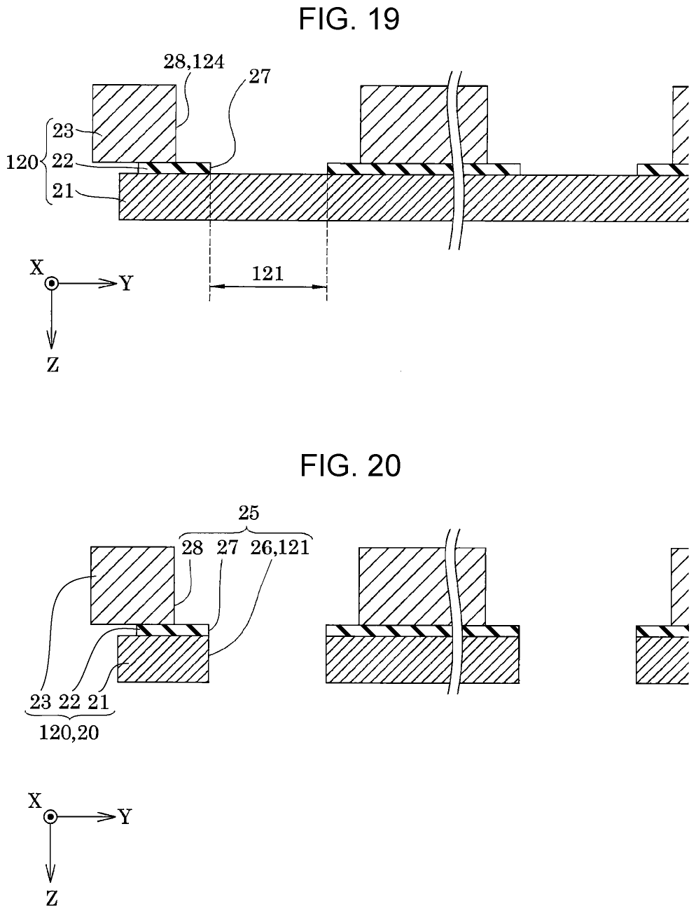

Then, the third step of providing the second nozzle opening 28 that communicates with the space portion 27 by conducting the Bosch process on the second region 124 (see FIG. 18) where at least a portion of the second nozzle layer 23 overlaps the space portion 27 is carried out as illustrated in FIG. 19 after the fifth step. In the present embodiment, the third step is carried out by conducting the Bosch process from the surface of the second nozzle layer 23 on the opposite side from the intermediate layer 22, that is to say, from the surface of the second nozzle layer 23 oriented to the −z direction. In this Bosch process of forming the second nozzle opening 28, notching is less likely to occur since the intermediate layer 22 is provided with the space portion 27. Accordingly, the groove is not formed at the boundary of the second nozzle opening 28 with the intermediate layer 22.

Next, the second step of providing the first nozzle opening 26 that communicates with the space portion 27 is carried out after the third step as illustrated in FIG. 20. Here, the first region 121 (see FIG. 19) where at least a portion of the first nozzle layer 21 overlaps the space portion 27 is subjected to the Bosch process from the second nozzle layer 23 side. In the second step, the surface of the first nozzle layer 21 on the second nozzle layer 23 side, that is to say, the surface oriented to the −z direction is covered with the intermediate layer 22. That is to say, in the second step, the first nozzle opening 26 is formed by conducting the Bosch process on the first nozzle layer 21 while using the intermediate layer 22 as a mask. In other words, the above-described fifth step is carried out after the first step and before the third step.

As described above, the first nozzle opening 26 is formed by conducting the Bosch process on the first nozzle layer 21 from the second nozzle layer 23 side. Accordingly, notching does not occur and the groove due to notching is not formed on the side wall of the first nozzle opening 26. Meanwhile, the length in the z axis direction of the first nozzle opening 26 is defined by the thickness of the first nozzle layer 21. Thus, it is possible to suppress the occurrence of a variation in length in the z axis direction of the first nozzle layer 21.

Thereafter, the first nozzle layer 21 is provided with the protection film 21a and the second nozzle layer 23 is provided with the protection film 23a as with FIG. 15 of the above-described Embodiment 1. In this way, the nozzle plate 20 is manufactured.

As described above, according to the method of manufacturing the nozzle plate 20 of the present embodiment, the groove is not formed due to notching at the boundary on the intermediate layer 22 side of the first nozzle opening 26. It is therefore possible to form the shape of the first nozzle opening 26 stably. Meanwhile, since it is possible to manage a length in the z axis direction of the first nozzle opening 26 by using the thickness of the first nozzle layer 21, the first nozzle opening 26 can be formed at a highly accurate length as compared to the case of adjustment by the etching period. Accordingly, it is possible to suppress the occurrence of a variation in ejection characteristics of the ink due to unstable shapes of the nozzles 25, and thus to suppress the occurrence of a variation in printing quality. Moreover, according to the method of manufacturing the nozzle plate 20 of the present embodiment, the groove is not formed due to notching at the second nozzle opening 28 either. This configuration can also suppress the occurrence of a variation in shape of the nozzles 25.

### Other Embodiments

The embodiments of the present disclosure have been described above. However, the basic configuration of the present disclosure is not limited to the above-described embodiments.

In each of the aforementioned embodiments, the drive element to create a change in pressure of the pressure chamber 12 has been described by using a thin film type piezoelectric actuator as an example. However, the drive element is not limited to this configuration. For instance, it is also possible to use a thick film type piezoelectric actuator formed in a process such as a method of attaching a green sheet, a longitudinal vibration type piezoelectric actuator formed by alternately laminating piezoelectric materials and electrode forming materials and configured to expand and contract in an axial direction, and so forth. Meanwhile, a heat generating element disposed inside a pressure generating chamber and configured to eject a liquid droplet from a nozzle by using a bubble generated by the heat of the heat generating element, a so-called electrostatic actuator configured to generate static electricity between a vibration plate and an electrode, and to eject a liquid droplet from a nozzle by deforming the vibration plate with electrostatic force, and the like can be used as the drive element.

In addition, the present disclosure is targeted for a wide range of liquid ejecting apparatuses provided with liquid ejecting heads as a whole. Examples of the liquid ejecting heads include various printing heads such as ink jet printing heads used for image printing apparatuses such as printers, and coloring material ejecting heads used for manufacturing color filters for liquid crystal display units and the like. More examples of the liquid ejecting heads include electrode material ejecting heads used for forming electrodes of organic electroluminescence (EL) display units, field emission display (FED) units, and the like, bioorganic material ejecting heads used for manufacturing biochips, and the like. The present disclosure is also applicable to liquid ejecting apparatuses adopting these liquid ejecting heads.

Meanwhile, the present disclosure has described the ink jet printing apparatus as an example of the liquid ejecting apparatus. However, the present disclosure is also applicable to liquid ejecting apparatuses adopting other liquid ejecting heads mentioned above.

In the above-described embodiments, the ink jet printing head configured to eject inks has been explained as an example of the liquid ejecting head and the ink jet printing apparatus has been explained as an example of the liquid ejecting apparatus. However, the present disclosure is targeted for a wide range of liquid ejecting heads and liquid ejecting apparatuses as a whole, and is of course applicable to liquid ejecting heads and liquid ejecting apparatuses configured to eject liquids other than inks. Examples of other liquid ejecting heads include various printing heads used for image printing apparatuses such as printers, coloring material ejecting heads used for manufacturing color filters for liquid crystal display units and the like, electrode material ejecting heads used for forming electrodes of organic EL display units, field emission display (FED) units, and the like, bioorganic material ejecting heads used for manufacturing biochips, and the like. The present disclosure is also applicable to liquid ejecting apparatuses adopting the above-mentioned liquid ejecting heads.

### Additional Statement

For example, the following configurations are conceived from the aspects exemplified above.

A method of manufacturing a nozzle plate according to Aspect 1 representing a preferred aspect provides a method of manufacturing a nozzle plate provided with a nozzle and configured to be attached to a liquid ejecting head. The method includes: a first step of preparing a substrate, in which a first nozzle layer formed from silicon, an intermediate layer formed from silicon oxide, and a second nozzle layer formed from silicon are laminated in enumerated order and a space portion is provided at a portion of the intermediate layer; a second step of providing a first nozzle opening that communicates with the space portion by conducting a Bosch process on a first region where at least a portion of the first nozzle layer overlaps the space portion, the second step being carried out after the first step; and a third step of providing a second nozzle opening that communicates with the space portion and has a larger diameter than a diameter of the first nozzle opening by conducting a Bosch process on a second region where at least a portion of the second nozzle layer overlaps the space portion.

According to this configuration, since the space portion is formed at the intermediate layer in advance when the first nozzle opening is formed in the second step, notching is less likely to occur when forming the first nozzle opening and a groove is not formed at the boundary of the first nozzle opening with the intermediate layer. Thus, the first nozzle opening can be formed into a desired shape at high accuracy. Moreover, the first nozzle opening can be formed at a highly accurate length by using the thickness of the first nozzle layer.

In Aspect 2 representing a specific example of the Aspect 1, the third step is carried out after the second step. According to this configuration, the second step and the third step can be carried out from the two surfaces of the substrate, and the nozzle can be formed at high accuracy.

In Aspect 3 representing a specific example of the Aspect 2, the method further includes a fourth step of forming an oxide film in such a way as to cover at least the first nozzle opening, the fourth step being carried out after the second step. Here, the third step is carried out after the fourth step. According to this configuration, the oxide film can keep the first nozzle opening from being etched when carrying out the third step.

In Aspect 4 representing a specific example of the Aspect 3, the method further includes a fifth step of thinning the second nozzle layer, the fifth step being carried out after the fourth step. According to this configuration, by not thinning the first nozzle layer, the first nozzle opening can be formed at a highly accurate length by using the thickness of the first nozzle layer. In addition, it is possible to form the nozzle plate in a desired thickness.

In Aspect 5 representing a specific example of the Aspect 2, the Bosch process is conducted from the first nozzle layer side in the second step, and the Bosch process is conducted from the second nozzle layer side in the third step. According to this configuration, it is possible to form the first nozzle opening and the second nozzle opening easily and at high accuracy in accordance with the Bosch processes.

In Aspect 6 representing a specific example of the Aspect 1, the third step is carried out after the first step and before the second step. According to this configuration, the third step can be carried out between the first step and the second step.

In Aspect 7 representing a specific example of the Aspect 6, the method further includes a fifth step of thinning the second nozzle layer, the fifth step being carried out after the first step and before the third step. According to this configuration, by not thinning the first nozzle layer, the first nozzle opening can be formed at a highly accurate length by using the thickness of the first nozzle layer. In addition, it is possible to form the nozzle plate in a desired thickness.

In Aspect 8 representing a specific example of the Aspect 6, the Bosch processes are conducted from the second nozzle layer side in the second step and the third step. According to this configuration, the first nozzle opening and the second nozzle opening can be formed by conducting the Bosch processes from the same surface side of the substrate.

In Aspect 9 representing a specific example of the Aspect 7, a surface on the second nozzle layer side of the first nozzle layer is covered with the intermediate layer in the second step. According to this configuration, the surface of the first nozzle layer is covered with the intermediate layer when carrying out the second step. Thus, the first nozzle layer can be kept from being etched when forming the second nozzle opening.

A liquid ejecting head according to Aspect 10 representing a preferred aspect provides a liquid ejecting head including a nozzle plate provided with a nozzle, and a pressure chamber substrate provided with a pressure chamber configured to apply a pressure to a liquid in order to eject the liquid from the nozzle. Here, a first nozzle layer formed from silicon, an intermediate layer formed from silicon oxide, and a second nozzle layer formed from silicon are laminated in an enumerated order in the nozzle plate. The first nozzle layer is provided with a first nozzle opening. The intermediate layer is provided with a space portion that communicates with the first nozzle opening. The second nozzle layer is provided with a second nozzle opening that communicates with the space portion and has a larger diameter than a diameter of the first nozzle opening. A scallop is formed at each of the first nozzle opening and the second nozzle opening. Meanwhile, a scallop is not formed at the space portion.

According to this configuration, the first nozzle opening and the second nozzle opening are provided with the scallops. In other words, the first nozzle opening and the second nozzle opening can be formed at high accuracy in accordance with the Bosch processes. On the other hand, no scallops are provided to the space portion. That is to say, the space portion has been formed in advance at the time of forming at least one of the first nozzle opening and the second nozzle opening. As a consequence, when forming at least one of the first nozzle opening and the second nozzle opening, a groove due to notching is not formed thanks to the space portion. Thus, it is possible to form the nozzle at high accuracy.

In Aspect 11 representing a specific example of the Aspect 10, a diameter of the space portion is larger than the diameter of the second nozzle opening. According to this configuration, the space portion forms a recess between the first nozzle opening and the second nozzle opening. The recess formed by the space portion can trap foreign matters included in the liquid, so that the first nozzle opening can be kept from clogging by the foreign matters. Meanwhile, when the second nozzle layer side of the nozzle plate is attached to a different component, it is possible to let an extra adhesive flow into the recess formed by the space portion so that the extra adhesive can be kept from flowing into the first nozzle opening side.

In Aspect 12 representing a specific example of the Aspect 10, the diameter of the space portion is larger than the diameter of the first nozzle opening and smaller than the diameter of the second nozzle opening. According to this configuration, the diameters are reduced stepwise from the second nozzle opening toward the first nozzle opening, and it is possible to eject the liquid from the nozzle without blocking the flow of the liquid.

In Aspect 13 representing a specific example of the Aspect 10, the diameter of the space portion is smaller than the diameter of the first nozzle opening. According to this configuration, even if foreign matters flow in from the first nozzle opening, the intermediate layer that projects from the first nozzle opening can keep the foreign matters from moving to the second nozzle opening.

In Aspect 14 representing a specific example of the Aspects 10 to 13, the intermediate layer is thinner than each of the first nozzle layer and the second nozzle layer. According to this configuration, it is possible to fully function the thin intermediate layer at the time of manufacturing the nozzle plate.

In Aspect 15 representing a specific example of the Aspect 14, the first nozzle layer is thinner than the second nozzle layer. According to this configuration, the length of the first nozzle opening can be defined by the thickness of the first nozzle layer. Moreover, the second nozzle layer can be used for adjusting the thickness of the nozzle plate.

In Aspect 16 representing a specific example of the Aspect 10, a groove is not formed at a boundary of the first nozzle layer with the space portion. According to this configuration, the shape of the first nozzle opening can be formed at high accuracy since the groove is not formed in the first nozzle layer.

In Aspect 17 representing a specific example of the Aspect 16, a groove is formed at a boundary of the second nozzle layer with the space portion. According to this configuration, the groove forms a recess between the first nozzle opening and the second nozzle opening. The recess formed by this groove can trap foreign matters included in the liquid, so that the first nozzle opening can be kept from clogging by the foreign matters. Meanwhile, when the second nozzle layer side of the nozzle plate is attached to a different component, it is possible to let an extra adhesive flow into the recess formed by the groove so that the extra adhesive can be kept from flowing into the first nozzle opening side. In addition, the groove at the second nozzle opening has a small impact on the ejection characteristics of the nozzle, so that deterioration in ejection characteristics can be suppressed.

In Aspect 18 representing a specific example of the Aspect 10, a diameter of the space portion at a position close to the second nozzle opening is larger than a diameter of the space portion at a position close to the first nozzle opening. According to this configuration, it is possible to form a recess on a side wall between the first nozzle opening and the second nozzle opening, and the recess can trap foreign matters included in the liquid and trap an extra adhesive. Moreover, the flow of the liquid can be blocked less.

A liquid ejecting apparatus according to Aspect 19 representing a preferred aspect includes the liquid ejecting head of above-mentioned aspect. According to this configuration, it is possible to realize a liquid ejecting apparatus that suppresses a variation in ejection characteristics and improves printing quality.

What is claimed is:

1. A method of manufacturing a nozzle plate provided with a nozzle and configured to be attached to a liquid ejecting head, comprising:
preparing a substrate, in which a first nozzle layer formed from silicon, an intermediate layer formed from silicon oxide, and a second nozzle layer formed from silicon are laminated in enumerated order and a space portion is provided at a portion of the intermediate layer;
providing a first nozzle opening that communicates with the space portion by conducting a Bosch process on a first region where at least a portion of the first nozzle layer overlaps the space portion, the providing the first nozzle opening being carried out after the preparing; and
providing a second nozzle opening that communicates with the space portion and has a larger diameter than a diameter of the first nozzle opening by conducting a Bosch process on a second region where at least a portion of the second nozzle layer overlaps the space portion.

2. The method of manufacturing a nozzle plate according to claim 1, wherein the providing the second nozzle opening is carried out after the providing the first nozzle opening.

3. The method of manufacturing a nozzle plate according to claim 2, further comprising:
forming an oxide film in such a way as to cover at least the first nozzle opening, the forming being carried out after the providing the first nozzle opening, wherein
the providing the second nozzle opening is carried out after the forming.

4. The method of manufacturing a nozzle plate according to claim 3, further comprising:
thinning the second nozzle layer, the thinning being carried out after the forming.

5. The method of manufacturing a nozzle plate according to claim 2, wherein
the Bosch process is conducted from the first nozzle layer side in the providing the first nozzle opening, and
the Bosch process is conducted from the second nozzle layer side in the providing the second nozzle opening.

6. The method of manufacturing a nozzle plate according to claim 1, wherein the providing the second nozzle opening is carried out after the preparing and before the providing the first nozzle opening.

7. The method of manufacturing a nozzle plate according to claim 6, further comprising:
thinning the second nozzle layer, the thinning being carried out after the preparing and before the providing the second nozzle opening.

8. The method of manufacturing a nozzle plate according to claim 6, wherein the Bosch processes are conducted from the second nozzle layer side in the providing the first nozzle opening and the providing the second nozzle opening.

9. The method of manufacturing a nozzle plate according to claim 7, wherein a surface on the second nozzle layer side of the first nozzle layer is covered with the intermediate layer in the providing the first nozzle opening.

10. A liquid ejecting head comprising:
a nozzle plate provided with a nozzle; and
a pressure chamber substrate provided with a pressure chamber configured to apply a pressure to a liquid in order to eject the liquid from the nozzle, wherein
a first nozzle layer formed from silicon, an intermediate layer formed from silicon oxide, and a second nozzle layer formed from silicon are laminated in an enumerated order in the nozzle plate,
the first nozzle layer is provided with a first nozzle opening,
the intermediate layer is provided with a space portion that communicates with the first nozzle opening,
the second nozzle layer is provided with a second nozzle opening that communicates with the space portion and has a larger diameter than a diameter of the first nozzle opening,
a scallop is formed at each of the first nozzle opening and the second nozzle opening, and
a scallop is not formed at the space portion.

11. The liquid ejecting head according to claim 10, wherein a diameter of the space portion is larger than the diameter of the second nozzle opening.

12. The liquid ejecting head according to claim 10, wherein a diameter of the space portion is larger than the diameter of the first nozzle opening and smaller than the diameter of the second nozzle opening.

13. The liquid ejecting head according to claim 10, wherein a diameter of the space portion is smaller than the diameter of the first nozzle opening.

14. The liquid ejecting head according to claim 10, wherein the intermediate layer is thinner than each of the first nozzle layer and the second nozzle layer.

15. The liquid ejecting head according to claim 14, wherein the first nozzle layer is thinner than the second nozzle layer.

16. The liquid ejecting head according to claim 10, wherein a groove is not formed at a boundary of the first nozzle layer with the space portion.

17. The liquid ejecting head according to claim 16, wherein a groove is formed at a boundary of the second nozzle layer with the space portion.

18. The liquid ejecting head according to claim 10, wherein a diameter of the space portion at a position close to the second nozzle opening is larger than a diameter of the space portion at a position close to the first nozzle opening.

19. A liquid ejecting apparatus comprising:
the liquid ejecting head according to claim 10.
